(19) United States
(12) Patent Application Publication
(10) Pub. No.: US 2025/0132436 A1
(43) Pub. Date: Apr. 24, 2025

(54) BATTERY SYSTEM, COOLER AND METHOD FOR MONITORING A BATTERY SYSTEM

(71) Applicant: SAMSUNG SDI CO., LTD., Yongin-si (KR)

(72) Inventor: Michael ERHART, Seiersberg-Pirka (AT)

(21) Appl. No.: 18/655,105

(22) Filed: May 3, 2024

(30) Foreign Application Priority Data
Oct. 19, 2023 (EP) 23204646.6

(51) Int. Cl. H01M 50/242; H01M 10/613; H01M 10/6556; H01M 50/249

(52) U.S. Cl. CPC H01M 50/242; H01M 10/613; H01M 10/6556; H01M 50/249; H01M 2200/20

(57) ABSTRACT

A battery system includes: a battery pack including a housing and a plurality of battery cells accommodated within the housing; an underbody protection structure; a cooler connected to and arranged between the battery cells and the underbody protection structure; and a pressure detection device. The cooler includes a cooling channel and a pressure detection channel separated from the cooling channel, and both the cooling channel and the pressure detection channel being arranged inside the cooler. The pressure detection device includes a pressure sensor connected to the pressure detection channel and configured to detect an underbody contact or impact event by monitoring a pressure in the pressure detection channel.

### CROSS REFERENCE TO RELATED APPLICATION

The present application claims priority to and the benefit of European Patent Application No. 23204646.6, filed on Oct. 19, 2023, in the European Union Intellectual Property Office, the entire disclosure of which is incorporated herein by reference.

### 1. FIELD

Aspects of embodiments of the present disclosure relate to a battery system, a cooler for the battery system, and a method for monitoring the battery system.

### 2. DESCRIPTION OF THE RELATED ART

Recently, vehicles for transportation of goods and peoples have been developed that use electric power as a source for motion. Such an electric vehicle is an automobile that is propelled by an electric motor using energy stored in rechargeable (or secondary) batteries. An electric vehicle may be solely powered by batteries or may be a hybrid vehicle powered by, for example, a gasoline generator. Furthermore, the vehicle may include a combination of an electric motor and a conventional combustion engine.

Generally, an electric-vehicle battery (EVB, or traction battery) is a battery used to power the propulsion of battery electric vehicles (BEVs). Electric-vehicle batteries differ from starting, lighting, and ignition batteries in that they are designed to provide power for sustained periods of time. A rechargeable (or secondary) battery differs from a primary battery in that it is designed to be repeatedly charged and discharged, while the latter provides an irreversible conversion of chemical to electrical energy. Low-capacity rechargeable batteries are used as power supply for small electronic devices, such as cellular phones, notebook computers, and camcorders, while high-capacity rechargeable batteries are used as power supply for hybrid vehicles and the like.

Generally, rechargeable batteries include an electrode assembly including a positive electrode, a negative electrode, and a separator interposed between the positive and negative electrodes, a case receiving (or accommodating) the electrode assembly, and an electrode terminal electrically connected to the electrode assembly. An electrolyte solution is injected into the case to enable charging and discharging of the battery via an electrochemical reaction of the positive electrode, the negative electrode, and the electrolyte solution. The shape of the case, such as cylindrical or rectangular, may be selected based on the battery's intended purpose. Lithium-ion (and similar lithium polymer) batteries, widely known via their use in laptops and consumer electronics, dominate the most recent group of electric vehicles in development.

Rechargeable batteries may be used as a battery module formed of a plurality of unit battery cells coupled to each other in series and/or in parallel to provide a high energy density, such as for motor driving of a hybrid vehicle. For example, the battery module may be formed by interconnecting the electrode terminals of the plurality of unit battery cells in an arrangement or configuration depending on a desired amount of power and to realize a high-power rechargeable battery.

Battery modules can be constructed in either a block design or a modular design. In the block design, each battery is coupled to a common current collector structure and a common battery management system, and the unit thereof is arranged in a housing. In the modular design, pluralities of battery cells are connected to form submodules, and several submodules are connected to form the battery module. In automotive applications, battery systems often consist of a plurality of battery modules connected to each other in series to provide a desired voltage. The battery modules may include submodules with a plurality of stacked battery cells, and each stack may include cells connected in parallel that are, in turn, connected in series (XpYs) or cells connected in series that are, in turn, connected in parallel (XsYp).

A battery pack is a set of any number of (often identical) battery modules. They may be configured in a series, parallel or a mixture of both to deliver the desired voltage, capacity, or power density. Battery packs include the individual battery modules and the interconnects, which provide electrical conductivity between them.

Conventional battery systems, despite any modular structure, usually include a battery housing that acts as an enclosure to seal the battery system against the environment and provides structural protection of the battery system's components. Housed battery systems are usually mounted as a whole into their application environment, such as an electric vehicle. Thus, replacement of defective or damaged system parts, such as a defective battery submodule, requires dismounting the entire battery system and removal of its housing. Even defects in small and/or cheap system parts might lead to the dismounting and replacement of the entire battery system and its separate repair. Because high-capacity battery systems are expensive, large, and heavy, this procedure is burdensome and the storage of the bulky battery systems, such as in the mechanic's workshop, becomes difficult.

A thermal management system to provide thermal control of the battery pack is often included to safely use the battery module by efficiently emitting, discharging, and/or dissipating heat generated by its rechargeable batteries. If the heat emission, discharge, and/or dissipation is not sufficiently performed, temperature deviations may occur between respective battery cells, such that the battery module may no longer generate a desired (or designed) amount of power. In addition, an increase in the internal temperature of the rechargeable batteries can lead to abnormal reactions occurring therein, and thus, charging and discharging performance of the rechargeable batteries deteriorates and the life-span of the rechargeable batteries is shortened.

Generally, a battery pack may have a cooler on its bottom side to cool the battery cells. Typically, an underbody structure is in place and used to protect the battery cells against underbody contact events (e.g., underbody impacts). If the electric vehicle drives over loose ground and stones are thrown up or a foreign object touches the ground plate of the electric vehicle, this might create an underground contact event. The underbody structure is designed in a way that the force will be distributed into cross beams of the underbody structure, and the battery cells should not be effected by such an underbody contact event.

### SUMMARY

According to embodiments of the present disclosure, a relatively low cost battery system is provided that can detect an underground contact event.

The present disclosure is defined by the appended claims and their equivalents. The description that follows is subjected to this limitation. Any disclosure lying outside the scope of the claims and their equivalents is intended for illustrative as well as comparative purposes.

According to an embodiment of the present disclosure, a battery system includes: a battery pack including a housing and a plurality of battery cells accommodated within the housing; an underbody protection structure; a cooler thermally connected to the battery cells and connected to an underbody protection structure; and a pressure detection device. The cooler is arranged between the underbody protection structure and the battery pack and includes a cooling channel and a pressure detection channel separated from the cooling channel and arranged inside the cooler. The pressure detection device includes a pressure sensor fluidly connected to the pressure detection channel and configured to detect an underbody contact or impact event by monitoring a pressure of a fluid in the pressure detection channel by using the pressure sensor.

According to another embodiment of the present disclosure, an electric vehicle including the above-described battery system is provided.

According to another embodiment of the present disclosure, a cooler for a battery system includes two metal sheets connected to each other. A cooling channel and a pressure detection channel separated from the cooling channel are arranged between the two metal sheets inside of the cooler.

Yet another embodiment of the present disclosure provides a method for monitoring the battery system described above and includes: continuously measuring a pressure of a fluid, such as a gaseous medium, in the pressure detection channel; and detecting an underbody contact or impact event in response to detecting a pressure pulse in the pressure detection channel that exceeds a threshold value.

Further aspects and features of the present disclosure can be learned from the dependent claims or the following description.

### BRIEF DESCRIPTION OF THE DRAWINGS

Aspects and features of the present disclosure will become apparent to those of ordinary skill in the art by describing, in detail, embodiments thereof with reference to the attached drawings, in which:

FIG. 1 is a schematic top view of a battery system according to an embodiment of the present disclosure.

FIG. 2 is a schematic side view of a battery system according to an embodiment of the present disclosure.

FIG. 3 illustrates an electric vehicle with a battery system according to an embodiment of the present disclosure.

FIG. 4 is a flowchart describing a method for monitoring a battery system and detecting underbody contact or impact events at the battery system according to an embodiment of the present disclosure.

### DETAILED DESCRIPTION

Reference will now be made, in detail, to embodiments, examples of which are illustrated in the accompanying drawings. Aspects and features of the present disclosure, and implementation methods thereof, will be described with reference to the accompanying drawings. The present disclosure may, however, be embodied in various different forms and should not be construed as being limited to the embodiments described herein. Rather, these embodiments are provided as examples so that this disclosure will be thorough and complete and will fully convey the aspects and features of the present disclosure to those skilled in the art. Accordingly, processes, elements, and techniques that are not considered necessary for those having ordinary skill in the art to have a complete understanding of the aspects and features of the present disclosure may not be described.

It will be understood that when an element or layer is referred to as being “on,” “connected to,” or “coupled to” another element or layer, it may be directly on, connected, or coupled to the other element or layer or one or more intervening elements or layers may also be present. When an element or layer is referred to as being “directly on,” “directly connected to,” or “directly coupled to” another element or layer, there are no intervening elements or layers present. For example, when a first element is described as being “coupled” or “connected” to a second element, the first element may be directly coupled or connected to the second element or the first element may be indirectly coupled or connected to the second element via one or more intervening elements.

In the figures, dimensions of the various elements, layers, etc. may be exaggerated for clarity of illustration. The same reference numerals designate the same elements. As used herein, the term “and/or” includes any and all combinations of one or more of the associated listed items. Further, the use of “may” when describing embodiments of the present disclosure relates to “one or more embodiments of the present disclosure.” Expressions, such as “at least one of” and “any one of,” when preceding a list of elements, modify the entire list of elements and do not modify the individual elements of the list. For example, the expression “at least one of a, b, or c” indicates only a, only b, only c, both a and b, both a and c, both b and c, all of a, b, and c, or variations thereof. As used herein, the terms “use,” “using,” and “used” may be considered synonymous with the terms “utilize,” “utilizing,” and “utilized,” respectively. As used herein, the terms “substantially,” “about,” and similar terms are used as terms of approximation and not as terms of degree, and are intended to account for the inherent variations in measured or calculated values that would be recognized by those of ordinary skill in the art.

It will be understood that, although the terms first, second, third, etc. may be used herein to describe various elements, components, regions, layers, and/or sections, these elements, components, regions, layers, and/or sections should not be limited by these terms. These terms are used to distinguish one element, component, region, layer, or section from another element, component, region, layer, or section. Thus, a first element, component, region, layer, or section discussed below could be termed a second element, component, region, layer, or section without departing from the teachings of example embodiments.

Spatially relative terms, such as “beneath,” “below,” “lower,” “above,” “upper,” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” or “over” the other elements or features. Thus, the term “below” may encompass both an orientation of above and below. The device may be otherwise oriented (rotated 90 degrees or at other orientations), and the spatially relative descriptors used herein should be interpreted accordingly.

The terminology used herein is for the purpose of describing embodiments of the present disclosure and is not intended to be limiting of the present disclosure. As used herein, the singular forms “a” and “an” are intended to include the plural forms as well, unless the context clearly indicates otherwise. It will be further understood that the terms “includes,” “including,” “comprises,” and/or “comprising,” when used in this specification, specify the presence of stated features, integers, steps, operations, elements, and/or components but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which the present disclosure belongs. It will be further understood that terms, such as those defined in commonly used dictionaries, should be interpreted as having a meaning that is consistent with their meaning in the context of the relevant art and/or the present specification, and should not be interpreted in an idealized or overly formal sense, unless expressly so defined herein.

Embodiments of the present disclosure are directed to a battery system including a battery pack including a housing and a plurality of battery cells accommodated within the housing and a cooler thermally connected to the battery cells and an underbody protection structure. The cooler is arranged between the underbody protection structure and the battery pack. The cooler includes at least one cooling channel and at least one pressure detection channel separated from the cooling channel and arranged inside the cooler. The battery system, according to an embodiment, further includes a pressure detection device with a pressure sensor fluidly connected to the pressure detection channel and configured to detect an underbody contact or impact event by monitoring the pressure in the pressure detection channel by using the pressure sensor. The battery system, according to embodiments of the present disclosure, allows for the detection an impact to an underbody protection structure of the battery system and for assessment the risk of damage to the battery system by the impact to the underbody protection system. The integration of the pressure detection channel into the cooler allows for an easier assembly process of the battery system and reduces costs because other methods and/or components (e.g., external components) for detecting an impact to the underbody can be omitted. Furthermore, by employing continuous monitoring of underbody contact or impact events, the weight of the underbody protection structure may be reduced. Further, reference (or threshold) values for a pressure pulse in the pressure detection channel can be set, which are directly related to the severity of an impact to the underbody protection structure.

According to embodiments of the present disclosure, a battery system is provided with a protection mechanism to easily detect underbody contact or impact events and to assess the severity of the underbody contact or impact event and its impact on the battery system. This allows for the repair of the battery system, if necessary or indicated, before damage progresses, especially in the case damage to the cooler, which may lead to a malfunction or destruction of the battery system.

In an embodiment of the present disclosure, the pressure detection channel is filled with a fluid, for example, a gaseous medium. Gaseous media is well suited for detection of a pressure pulse and transmission of the same to a pressure sensor to detect the underbody contact or impact event.

For example, the gaseous medium may be air, oxygen, carbon dioxide, or nitrogen. Air, oxygen, carbon dioxide, or nitrogen are gases that are available at relatively low cost and do not easily volatilize, so that a constant filling of the channels with a gaseous medium can be ensured. Therefore, these gases may be used to fill the pressure detection channels.

According to an embodiment of the present disclosure, the cooler includes two metal sheets connected to each other, and the cooling channel and the pressure detection channel are arranged between (or are formed between) the two metal sheets. The production of the cooler from two metal sheets allows for the relatively cheap production of the cooler. In addition, both the cooling channels and the pressure detection channels can be integrated into such a cooler in a simple and cost-effective manner.

In an embodiment of the present disclosure, the cooling channel and/or the pressure detection channel are implemented in at least one of the metal sheets. Implementing the cooling channel(s) or the pressure detection channel in one of the metal sheets is an easy and relatively inexpensive way to manufacture a cooler.

In an embodiment of the present disclosure, the cooling channel is designed as a meandering cooling channel and the pressure detection channel extends into loops of the meandering cooling channel. A combination of the meander-shaped cooling channels and pressure detection channels, which are arranged in the loops of the meandering cooling channels, allows for both good cooling of the battery system and uniform coverage with pressure detection channels so that a contact or impact in all areas of the underbody can be detected and evaluated correspondingly well.

According to an embodiment of the present disclosure, the underbody protection structure includes at least one support element configured to distribute a force due to an underbody contact or impact event into the support element via the cooler. The support element allows the forces from the underbody protection structure to be introduced into (e.g., to be passed onto) the cooler and deflected from the area of the battery cells of the battery system. This reduces the risk of a battery cell being damaged by an underbody contact or impact event.

In an embodiment of the present disclosure, the support element includes one or more cross beams. Cross beams absorb forces in the X-direction as well as in the Y-direction. In addition, in the case of an underbody contact or impact event, the cross beams can act as deformation elements, which deform in the Z-direction so that impact forces are reduced by elastic or plastic deformation of the cross beams and only minimal or no impact forces are passed onto into the cooler. This can further reduce the risk of damage to the cooler and/or a battery cell of the battery system.

In an embodiment of the present disclosure, the support element is configured to distribute a force occurring due to an underbody event into an area of the cooler, and the pressure detection channel is arranged in this area of the cooler. This makes the detection and the assessment of an underbody contact or impact event more precise and allows for the assessment as to whether or not a contact or impact event of the underbody protection structure is critical to the cooler or the battery cells.

In an embodiment of the present disclosure, the underbody protection structure includes protrusions located on a side of the underbody protection structure facing away from the battery pack. The protrusions can act as stiffening ribs to increase the strength of the underbody protection structure. Furthermore, the protrusions can be removed from the underbody protection structure as wear material in the event of underbody contact or underbody impact so that the durability of the underbody protection structure can be increased. This can improve the protection of the cooler and the battery cells of the battery system.

In an embodiment of the present disclosure, the cooler is manufactured by a roll-bonding process. A roll-bonding process is a process for building radiators or cooler in a simple and cost-effective way. A roll-bonding process allows two metal sheets of the cooler to be joined by using a high-pressure rolling process. This allows for a fluid-tight connection between the two metal sheets.

In an embodiment of the present disclosure, the cooling channel and/or the pressure detection channel are formed by using a high-pressure forming process. For this purpose, a fluid is fed under high pressure into the channels of the cooler to inflate them to their desired shape and to build (or form) the cooling channels and the pressure detection channels.

According to another embodiment of the present disclosure, an electric vehicle including a battery system as described above is provided. Electric vehicles generally have a battery system located in an underbody position of the vehicle. While driving the electric vehicle, an underbody contact or impact event can occur by whirled up stones or other subjects or by the electric vehicle driving over bollard, stones, or similar objects that can hit (or impact) the underground protection structure. This causes an underbody contact or impact event that could damage the cooler or the battery cells of the battery systems. The pressure detection channels not only detect such an underground body contact event but also allow for the assessment of the severity of such an underbody contact event.

If the impact is light (or low force), the cooler and the battery cells will most likely not be affected by the impact. A first reference (or threshold) value may be set for the pressure pulse resulting from an underbody contact event which is deemed to be uncritical to the battery system. If the pressure pulse exceeds the first reference value, a check (or inspection) of the battery system is recommended. Such a recommendation can be sent to the dashboard of the electric vehicle to inform the drives that an underbody contact event has occurred which could have caused damage of the battery system. If the pressure pulse exceeds a second reference (or threshold) value, it is likely that the impact was hard (or high force), and that the cooler and/or a battery cell of the battery system was damaged. Damage to the cooler may lead to insufficient cooling of the battery cells of the battery system and could lead to thermal damage of at least one battery cell. In the case of a damaged battery cell, electrolyte might run out of the damaged battery cell and may cause severe damage to the other battery cells in the battery system. Furthermore, the electrolyte running out of the battery cell might increase the risk for burning battery cells (e.g., may increase the risk of fire) and a thermal runaway of the battery system and must be avoided. If the pressure pulse exceeds the second reference value, the driver is informed about a severe underbody impact event and prompted to go to a repair station to check the battery system without delay.

According to another embodiment of the present disclosure, a cooler for a battery system as described in the above paragraphs is provided including two metal sheets connected to each other and at least one cooling channel and at least one pressure detection separated from the cooling channel arranged between the two metal sheets inside of the cooler. The cooler may include a plurality of cooling channels and a plurality of pressure detection channels arranged within the two metal sheets of the cooler. The cooler allows for easy integration of the pressure detection channel and a cooling channel into the cooler to simplify the assembly of the battery system and allow for simple, permanent monitoring of the battery system for underbody contact or impact events that could lead to a damage of the battery system.

Yet another embodiment of the present disclosure is directed to a method for monitoring a battery system including: providing a battery system as described in the above paragraphs; continuously measuring a pressure of a fluid, for example, a gaseous medium in the at least one pressure detection channel; and detecting an underbody contact or impact event when a pressure pulse in the at least one pressure detection channel exceeds a reference (or threshold) value.

This method allows for the permanent monitoring of the battery system for underbody contact or impact events. This method allows for not only the detection of an underground body contact event but also allows for the assessment of the severity of an underbody contact event. If the impact is light, the cooler and the battery cells will most likely not be affected by the impact. A first reference (or threshold) value for the pressure pulse resulting from an underbody contact event, which is deemed to be uncritical to the battery system, may be set. If the pressure pulse exceeds this first reference value, a check for the battery system is recommended. Such a recommendation can be sent to the dashboard of the electric vehicle to inform the drives that an underbody contact event has occurred that could have led to possible damage to the battery system. If the pressure pulse exceeds a second reference (or threshold) value, it is likely that the impact was hard, and that the cooler and/or a battery cell of the battery system was damaged. Damage to the cooler can lead to insufficient cooling of the battery cells of the battery system and could lead to a thermal damage of at least one battery cell. Therefore, the driver is requested to immediately drive to a workshop and have the battery system checked to avoid consequential damage to the battery system or a danger to the environment, especially due to leaking electrolyte.

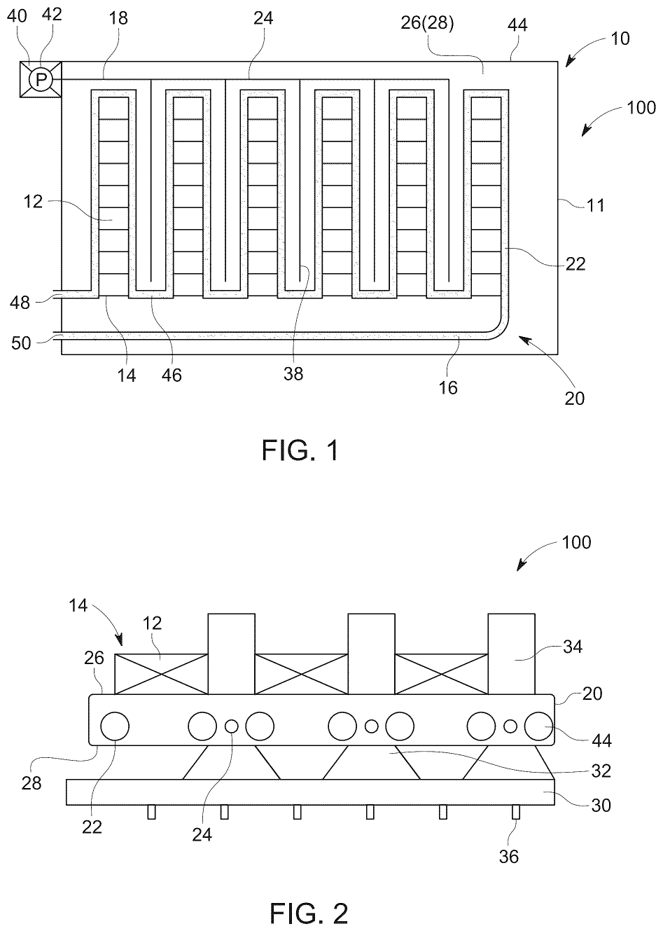

FIG. 1 is a top view of a battery system 100 according to an embodiment of the present disclosure. The battery system 100 includes a battery pack 10 including a plurality of battery cells 12 arranged in at least one battery cell stack 14. The battery pack 10 further includes a housing 11 in which the battery cells 12 of the battery cell stack 14 are arranged.

The battery system 100 further includes a cooler 20 fluidly connected to the battery pack 10 to cool the battery cells 12 by transferring heat from the battery cells 12 via a cooling liquid 16. The cooler 20 is thermally connected to the battery cells 12 of the battery pack 10. The cooler 20 includes an inlet 48 and an outlet 50 connected by at least one cooling channel 22. The cooler 20 further includes at least one pressure detection channel 24 separated from the cooling channel 22.

In the embodiment shown in FIG. 1, the cooler 20 includes a meandering cooling channel 22 and a pressure detection channel 24. The pressure detection channel 24 includes a main channel 18 connected to a pressure detection device 40 and a plurality of stub channels 38 extending from the main channel 18 into (or between) loops 46 of the meander of the cooling channel 22. The cooler 20 includes a first metal sheet 26 and a second metal sheet 28 (see, e.g., FIG. 2), and the at least one cooling channel 22 and the at least one pressure detection channel 24 are arranged in a cavity bounded by (or formed between) the two metal sheets 26, 28. The first metal sheet 26 and the second metal sheet 28 are connected by a fluid tight connection 44 which can be achieved by a roll-bonding or welding process of the two metal sheets 26, 28.

The battery systems 100 further includes an underbody protection structure 30 (see, e.g., FIG. 2) to protect the battery system 100 from underbody contact or impact events. The underbody protection structure 30 includes at least one support element 32 (see, e.g., FIG. 2). The support element 32 is arranged to introduce (or distribute) a force acting on the underbody protection structure 30 into the cooler 20 and, thus, to prevent mechanical overloading of the battery cells 12 in the event of an impact on the underbody protection structure 30. The cooler 20 is arranged between the underbody protection structure 30 and the battery pack 10 to provide a compact design of the battery pack 10 and a relatively simple assembly of the battery system 100. Furthermore, the cooler 20 is designed to form a deformation zone to protect the battery pack 10 and to prevent damage to the battery cells 12 in the event of a severe impact on the underbody protection structure 30.

The pressure detection device 40 includes at least one pressure sensor 42 fluidly connected to the pressure detection channel 24 to detect a pressure pulse in the pressure detection channel 24 due to an underbody contact or impact event. The pressure sensor 42 is configured to monitor the pressure in the pressure detection channel 24. A battery pack generally has a cooler on its bottom side to cool the battery cells of the battery pack. Thus, the cooler 20 may be covered by the underbody protection structure 30, which protects the battery pack 10 against underbody contact or impact events.

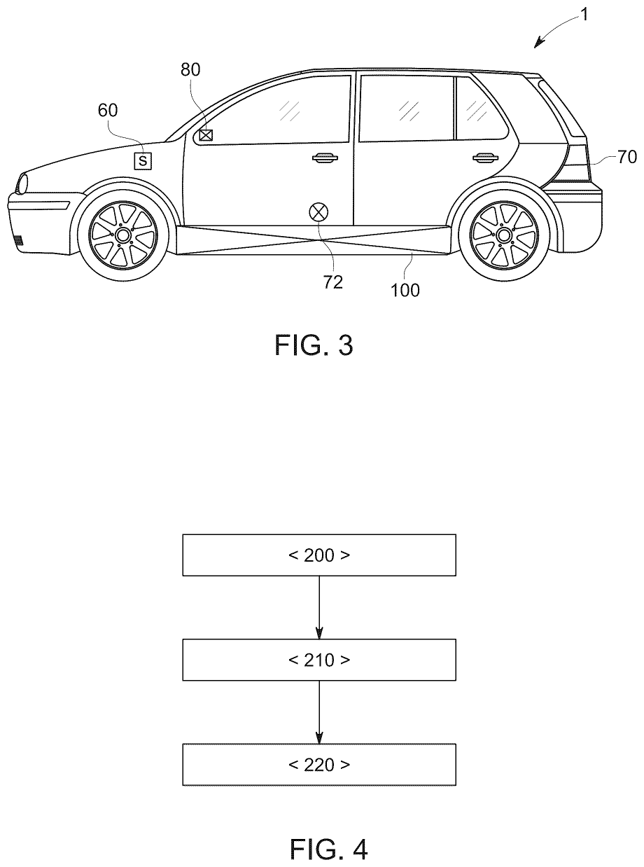

If an electric vehicle 1 including the battery system 100 (see, e.g., FIG. 3) runs over a bollard, automobile jacks, stones, or similar objects, an underbody contact or impact event may occur. The underbody protection structure 30 is designed or configured such that the forces occurring due to the underbody contact event are distributed into the support element 32 so that the battery cells 12 should not be influenced by the impact force. In an embodiment, the cooler 20 includes at least one cooling channel 22 filled with the cooling liquid 16 and at least one pressure detection channel 24 filled with a gaseous medium, such as air, nitrogen, carbon dioxide, or oxygen. The pressure sensor 42 is installed at the end of the pressure detection channel 24. If an underbody contacts or impact event occurs, an impact force is exerted on (or acts on) the underbody protection structure 30, which is introduced into (or distributed to) the cooler 20 through the support element 32. In the case of an underbody contact or impact event, the pressure detection channel 24 will be squeezed (or compressed), which will lead to a pressure pulse (or pressure spike or increase) measured by the pressure sensor 42.

FIG. 2 is a schematic side view of the battery system 100 according to an embodiment of the present disclosure. The battery system 100 includes a battery pack 10, an underbody protection structure 30, and a cooler 20 arranged between the underbody protection structure 30 and the battery pack 10. The battery pack 10 includes a plurality of battery cells 12 arranged in at least one battery cell stack 14. The cooler 20 includes cooling channels 22 and pressure detection channels 24 separated from the cooling channels 22, and the cooling channels 22 and the pressure detection channels 24 are arranged inside the cooler 20.

The underbody protection structure 30 includes support elements 32, including at least one cross beam 34. The cross beam 34 is configured to distribute an impact force of an underbody impact event into the cooler 20 and to prevent the battery cells 12 from being damaged by such an impact force.

The underbody protection structure 30 may also include at least one protrusion 36 located on a side of the underbody protection structure 30 facing away from the battery pack 10 and oriented towards a floor surface under a vehicle in which the battery system 100 is installed. The protrusion 36 can act as a stiffening rib for the underbody protection structure 30. The protrusion 36 can also act as a wear layer, which is removed (or worn down) in the event of underbody contact so that the remaining structure of the underbody protection structure 30 is not damaged.

FIG. 3 is a schematic illustration of an electric vehicle 1 according to an embodiment of the present disclosure. The electric vehicle 1 includes the battery system 100 as described in the above paragraphs, an electric motor 60, and a chassis 70. The battery system 100 is installed on the bottom side of the chassis 70. The battery system 100 is located on the underside of the electric vehicle 1 to keep the vehicle's center of gravity 72 as low as possible and, thus, to improve the handling of the electric vehicle 1.

FIG. 4 is a flowchart describing a method for monitoring a battery system 100 and detecting underbody contact or impact events on the battery system 100 according to an embodiment of the present disclosure.

In a first step <200> of the method, a battery system 100 as described above is provided.

In a second step <210>, a pressure of a gaseous medium in the at least one pressure detection channel 24 is continuously measured.

In a step <220>, a pressure pulse exceeding a reference (or threshold) value is detected in the at least one pressure detection channel 24 due to an underbody contact or impact event of the underbody protection structure 30. In response, the driver will be informed that there was an underbody impact event. If the event was assessed to be hard enough (or high force) that the pressure pulse exceeds the reference value, the driver will be informed by the dashboard 80 to go to a repair shop and have the battery system 100 checked (or inspected). If the cooler 20 was damaged by an impact, a battery cell 12 may also be damaged. A damaged battery cell 12 can lead to electrolyte leakage and an increased risk of further damage to the battery pack 10 or harm to the environment. If the cooler 20 was not damaged by the underbody contact or impact event, the battery cells 12 will most like also not be affected (or damaged) by the underbody contact event. By this measurement of the underbody contact event, the weight of the underbody protection structure 30 may be reduced and the weight and cost of the battery system 100 may also be reduced.

SOME REFERENCE NUMERALS

| | | | |
|---|---|---|---|
| 1 | electric vehicle | 10 | battery pack |
| 11 | housing | 12 | battery cell |
| 14 | battery cell stack | 16 | cooling liquid |
| 18 | main channel | 20 | cooler |
| 22 | cooling channel | 24 | pressure detection channel |
| 26 | first metal sheet | 28 | second metal sheet |
| 30 | underbody protection structure | 32 | support element |
| 34 | cross beam | 36 | protrusion |
| 38 | stub channels | 40 | pressure detection device |
| 42 | pressure sensor | 44 | connection |
| 46 | loop | 48 | inlet |
| 50 | outlet | 60 | electric motor |
| 70 | chassis | 72 | center of gravity |
| 80 | dashboard | 100 | battery system |

What is claimed is:

1. A battery system comprising:
a battery pack comprising a housing and a plurality of battery cells accommodated within the housing;
an underbody protection structure;
a cooler thermally connected to the battery cell and connected to the underbody protection structure, the cooler being arranged between the battery cells and the underbody protection structure, the cooler comprising a cooling channel and a pressure detection channel separated from the cooling channel, both the cooling channel and the pressure detection channel being arranged inside the cooler; and
a pressure detection device comprising a pressure sensor connected to the pressure detection channel and configured to detect an underbody contact or impact event by monitoring a pressure in the pressure detection channel.

2. The battery system as claimed in claim 1, wherein the pressure detection channel is filled with a fluid.

3. The battery system as claimed in claim 2, wherein the fluid is a gaseous medium.

4. The battery system as claimed in claim 1, wherein the cooler comprises two metal sheets connected to each other, and
wherein the cooling channel and the pressure detection channel are arranged between the two metal sheets.

5. The battery system as claimed in claim 4, wherein the cooling channel and/or the pressure detection channel are formed in at least one of the two metal sheets.

6. The battery system as claimed in claim 1, wherein the cooling channel is as a meandering cooling channel having at least one loop, and
wherein the pressure detection channel extends between the loop of the meandering cooling channel.

7. The battery system as claimed in claim 1, wherein the underbody protection structure comprises a support element configured to distribute a force of an underbody contact or impact event into the support element via the cooler.

8. The battery system as claimed in claim 7, wherein the support element comprises a cross beam.

9. The battery system as claimed in claim 8, wherein the support element is configured to distribute the force into an area of the cooler where the pressure detection channel is arranged.

10. The battery system as claimed in claim 1, wherein the underbody protection structure comprises protrusions on a side of the underbody protective structure facing away from the battery pack.

11. The battery system as claimed in claim 1, wherein the cooler is manufactured by a roll-bonding process.

12. The battery system as claimed in claim 11, wherein the cooling channel and/or the pressure detection channel are formed by a high-pressure forming process.

13. An electric vehicle comprising the battery system as claimed in claim 1.

14. A cooler for a battery system, the cooler comprising two metal sheets connected to each other,
wherein a cooling channel and a pressure detection channel separated from the cooling channel are arranged between the two metal sheets inside of the cooler.

15. A method for monitoring the battery system as claimed in claim 1, the method comprising:
continuously measuring a pressure of a fluid in the pressure detection channel; and
detecting an underbody contact or impact event in response to detecting a pressure pulse in the pressure detection channel that exceeds a reference value.
